(19) United States
(12) Patent Application Publication
(10) Pub. No.: US 2012/0275635 A1
(43) Pub. Date: Nov. 1, 2012

(54) EARPHONE WITH MUTUALLY OBLIQUELY ORIENTED SOUND HOLES

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/207,462

(22) Filed: Aug. 11, 2011

(30) Foreign Application Priority Data
Apr. 27, 2011 (CN) 201110106467.0

(51) Int. Cl. H04R 25/00

(52) U.S. Cl. 381/380

(57) ABSTRACT

An exemplary earphone includes a shell and a speaker mounted in the shell. The speaker divides a sound cavity of the shell into a front chamber at a front side of the speaker and a rear chamber at a rear side of the speaker. The shell includes a front wall confronting the speaker and a side wall extending obliquely from an edge of the front wall to the speaker. A first sound hole is defined in the front wall to communicate the front chamber of the shell with outer environment. A second sound hole is defined in the side wall to communicate the front chamber of the shell with outer environment. When the earphone is in use, the first sound hole is corresponding to a concha of human ear and the second sound hole is corresponding to an entrance of an external auditory meatus of human ear.

### BACKGROUND

1. Technical Field

The disclosure generally relates to earphones.

2. Description of Related Art

A typical earphone includes a shell and a speaker mounted in the shell. The shell defines a sound cavity therein, and the speaker divides the sound cavity into a front chamber and a rear chamber. The shell has a side wall at a front side of the speaker. The side wall defines through holes to communicate the front chamber with the outer environment, so that sound produced by the speaker is output to a user. Because the through holes are aligned with the speaker, the sound quality of the earphone at intermediate frequencies and high frequencies is improved. However, the sound quality of the earphone at low frequencies is relatively poor.

In order to improve the sound quality of the typical earphone at low frequencies, a spherical protrusion is defined in the side wall of the shell, and the through holes are defined in an end of the protrusion. With this kind of improved earphone, the protrusion is inserted into an outmost portion of the auditory meatus of the human ear, and prevents unwanted sound from the external environment from entering the ear. Thus, sound outputted from the through holes of the protrusion transmit into the ear without disturbance by external unwanted sounds. However, if something happens in the external environment with an accompanying audible alert of some kind, the user of the earphone may not receive the audible information immediately and an accident may occur.

What is needed, therefore, is an earphone to overcome the described limitations.

### BRIEF DESCRIPTION OF THE DRAWINGS

FIG. 1 is an isometric view of an earphone in accordance with an embodiment of the present disclosure.

FIG. 2 is an exploded view of the earphone in FIG. 1.

FIG. 3 is an isometric view of a front shell of the earphone in FIG. 2, showing an inner side of the front shell.

FIG. 4 is a cross-sectional view of the earphone in FIG. 1, taken along line IV-IV thereof.

FIG. 5 is a schematic view of part of a left-side human ear.

### DETAILED DESCRIPTION

An embodiment of an earphone will now be described in detail below and with reference to the drawings.

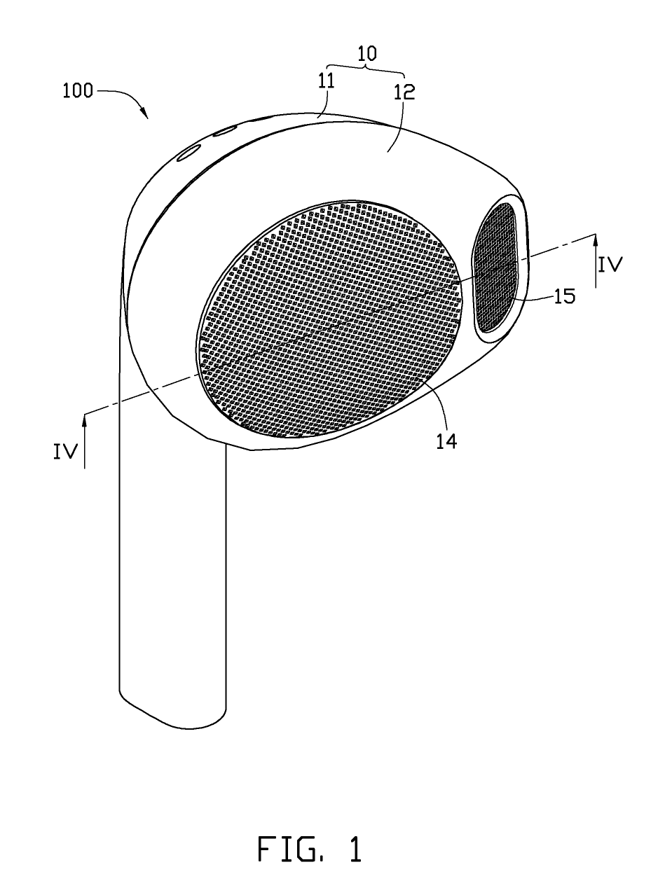

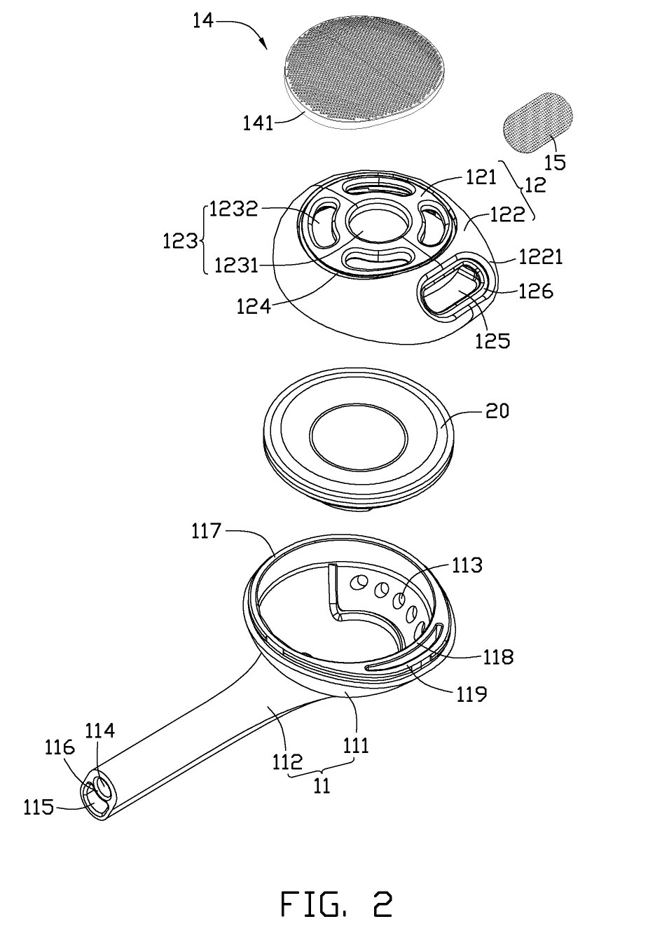

Referring to FIGS. 1-2, the earphone 100 includes a shell 10 and a speaker 20 received in the shell 10. In this embodiment, the earphone 100 is a left-ear earphone for positioning in the left ear of a human being.

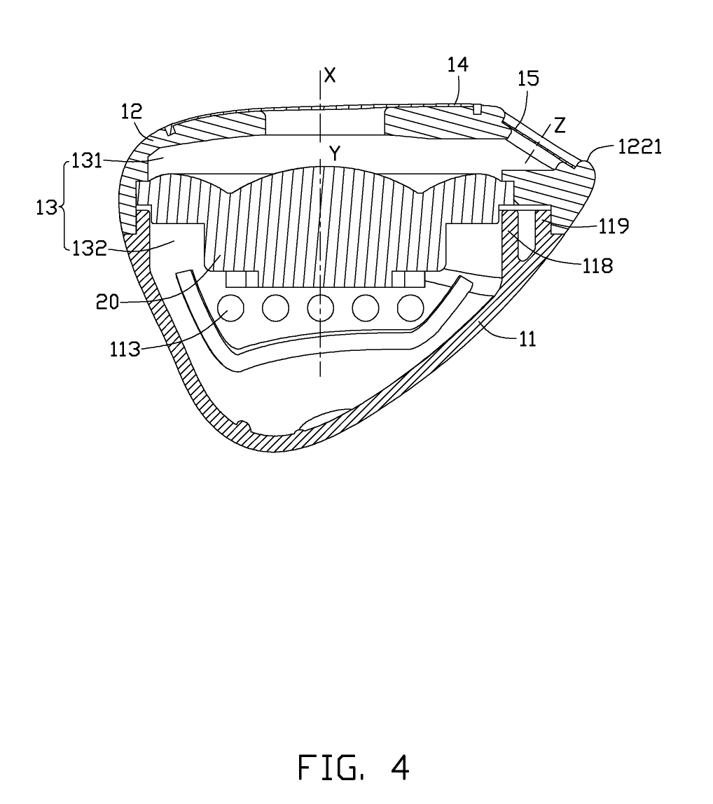

Further referring to FIG. 4, the shell 10 includes a rear cover 11 and a front cover 12 engaged with the rear cover 11. The rear cover 11 and the front cover 12 cooperatively define a sound cavity 13. The speaker 20 is mounted in the sound cavity 13, and divides the sound cavity 13 into a front chamber 131 and a rear chamber 132. The front chamber 131 is located at a front side of the speaker 20, and the rear chamber 132 is located at a rear side of the speaker 20.

Referring to FIG. 2, the rear cover 11 includes a main body 111 and a handle portion 112 extending outwardly from the main body 111. The main body 111 is approximately cone-shaped. A number of air holes 113 are defined in a side of the main body 111 to communicate the rear chamber 132 with the outer environment. The handle portion 112 is tubular, and extends from a side of the main body 111 opposite to the side having the air holes 113. The handle portion 112 defines a wire passage 114, and a sound passage 115 separated from the wire passage 114 by a spacing member 116. Both the wire passage 114 and the sound passage 115 communicate the rear chamber 132 with the outer environment. Wires (not shown) are located in the wire passage 114 to electrically connect the speaker 20 with an external power source. The sound passage 115 is configured to adjust the sound quality of the earphone 100.

The main body 111 of the rear cover 11 defines an annular wall 117 confronting the front cover 12. The annular wall 117 has a circular inner contour and an elliptical outer contour, and includes a first section 118 and a second section 119 separated from each other by an arc-shaped gap. The first section 118 is part of an inner portion of the annular wall 117 to secure the speaker 20. The second section 119 is part of an outer portion of the annular wall 117 to engage with the front cover 12.

The speaker 20 is disc-shaped and secured to the annular wall 117 of the main body 111. A sound outputting surface of the speaker 20 faces the front cover 12. In this embodiment, the speaker 20 is a moving-coil loudspeaker.

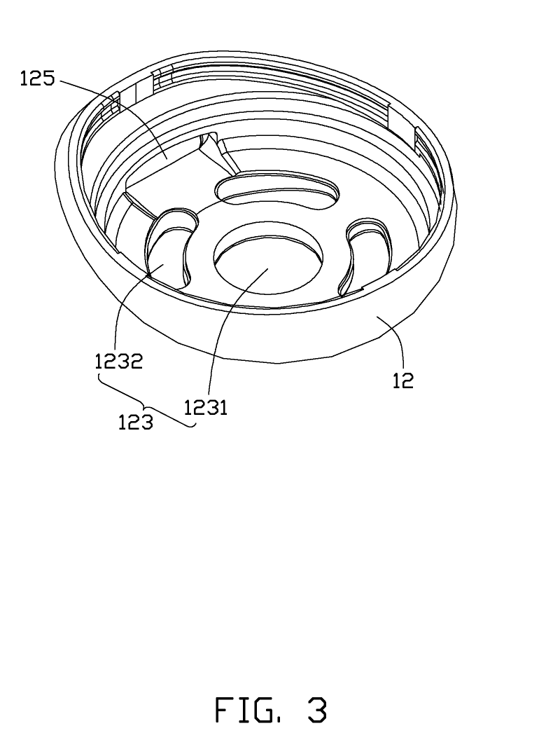

Referring also to FIG. 3, the front cover 12 has a front wall 121 confronting the speaker 20, and a peripheral side wall 122 extending from a periphery of the front wall 121 towards the rear cover 11. The front wall 121 is circular, and slightly protrudes out from the side wall 122. The front wall 121 defines a number of first sound holes 123 to communicate the front chamber 131 with the outer environment. In this embodiment, the first sound holes 123 includes a first through hole 1231 in the middle of the front wall 121, and four second through holes 1232 surrounding the first through hole 1231. The first through hole 1231 is circular, and the second through holes 1232 are arc-shaped. The front cover 12 has a center axis X, and the second through holes 1232 are equally angularly arranged around the center axis X. In this embodiment, the center axis X of the front cover 12 coincides with a center axis of the first sound hole 123. In alternative embodiments, the first sound hole 123 can only include the first through hole 1231 or the second through holes 1232. In other alternative embodiments, there can be three or five second through holes 1232.

A first netting cover 14 is attached to the front wall 121 to cover the first sound hole 123. Thereby, external contaminants are prevented from entering the front chamber 131 of the shell 10 through the first sound hole 123. The first netting cover 14 is circular, and protrudes slightly out from the front wall 121. The first netting cover 14 has a mesh to allow sound from the speaker 20 to pass through the first sound hole 123 and the first netting cover 14 to the outer environment. In this embodiment, the first netting cover 14 is wire netting. A flange 141 is formed at an edge of the first netting cover 14. The front cover 12 defines an annular groove 124 between the front wall 121 and the side wall 122. The flange 141 of the first netting cover 14 can be engaged in the annular groove 124, thereby attaching the first netting cover 14 to the front cover 12.

The side wall 122 of the front cover 12 has a generally elliptical contour overall. The side wall 122 is inclined relative to the front wall 121, and has a curved outer surface. The side wall 122 has an end section 1221 adjacent to the front wall 121. The end section 1221 defines a second sound hole 125 to communicate the front chamber 131 of the shell 10 with the outer environment. An area of the end section 1221 is less than an area of the front wall 121. An area of the second sound hole 125 is less than an area of the first sound hole 123. In this embodiment, each of the second sound hole 125 and the end section 1221 is rectangular, but with rounded ends. Put another way, each of the second sound hole 125 and the end section 1221 is in the shape of a flattened ellipse. The second sound hole 125 has a center axis Z (see FIG. 4). The outer surface of the side wall 122 defines a step 126 around the second sound hole 125. A second netting cover 15 is positioned on the step 126 to cover the second sound hole 125, to prevent external contaminants from entering the front chamber 131 of the shell 10 through the second sound hole 125. The second netting cover 15 has a mesh to allow sound from the speaker 20 to pass therethrough. The area of the second netting cover 15 is less than the area of the first netting cover 14, and the size of the mesh in the second netting cover 15 is less than that of the mesh in the first netting cover 14. In this embodiment, the second netting cover 15 is made of nylon netting or adhesive-bonded fabric. The edge of the second netting cover 15 is secured to the step section 126.

Referring to FIG. 4, when assembling the earphone 100, the speaker 20 is mounted in the annular wall 117 of the rear cover 11. The rear end of the side wall 122 is attached to the outer surface of the annular wall 117 and engaged with the main body 111. The front wall 121 of the front cover 12 faces the speaker 20, and the end section 1221 of the side wall 122 is located obliquely relative to the speaker 20. The center axis X of the front wall 121 coincides with a center axis Y of the speaker 20. In an alternative embodiment, the center axis X of the front wall 121 can be parallel to the center axis Y of the speaker 20. The center axis Z of the second sound hole 125 is inclined relative to the center axis Y of the speaker 20, and an included angle between the center axis Z of the second sound hole 125 and the center axis Y of the speaker 20 is an acute angle. In this embodiment, the included angle between the center axis Z of the second sound hole 125 and the center axis Y of the speaker 20 is less than 75 degrees and greater than 15 degrees. Similarly, the included angle between the center axis Z of the second sound hole 125 and the center axis X of the front wall 12 is less than 75 degrees and greater than 15 degrees.

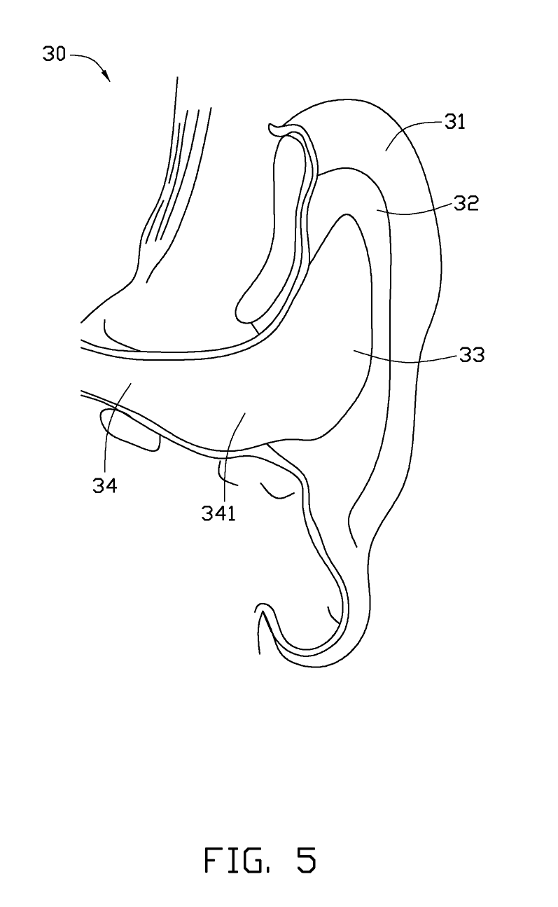

Referring to FIG. 5, an external auditory portion 30 of a human ear is shown. The external auditory portion 30 includes a helix 31, an antihelix 32, a concha 33 and an external auditory meatus 34. The external auditory meatus 34 has an entrance 341. When the earphone 100 is positioned at the external auditory portion 30, the end section 1221 of the front cover 12 is locating at the entrance 341 of the external auditory meatus 34 and not inserted into the external auditory meatus 34. In addition, the end section 1221 is elliptical-shaped and can not cover the entrance 341 of the external auditory meatus 34 completely. A gap between the end section 1221 and an edge of the entrance 341 of the external auditory meatus 34 allows external sound to enter the external auditory meatus 34. The front wall 121 with the first sound hole 123 faces the concha 33.

When the speaker 20 of the earphone 100 is in operation, the speaker 20 pushes air in the front chamber 131 and generates sound. Part of the sound generated by the speaker 20 enters the external auditory meatus 34 through the second sound hole 125. Another part of the sound generated by the speaker 20 passes through the first sound hole 123 and enters the external auditory meatus 34 through the gap between the edge of the end section 1221 and the entrance 341. Therefore, the sound from the first sound hole 123 and the sound from the second sound hole 125 are intermixed and heard by a user.

In the earphone 100 described above, sound in the intermediate or high frequency range (5 KHz-20 KHz) passes through the first sound hole 123 without distortion, and sound in the low frequency range (50 Hz-5 KHz) passes through the second sound hole 125 without distortion. Therefore, the sound quality of the earphone 100 is improved. In particular, when the included angle between the center axis of the second sound hole 125 and the center axis of the speaker 20 is less than 75 degrees and greater than 15 degrees, the shape of the front cover 12 of the earphone 100 matches the structure of the external auditory portion 30 of the human ear. The second sound hole 125 of the front cover 12 is fitted into the entrance 341 of the external auditory meatus 34, and sound can enter the external auditory meatus 34 from the second sound hole 125 easily.

In addition, the end section 1221 of the side wall 122 does not prevent sound from the first sound hole 123 reaching the external auditory meatus 34, and so the sound quality of the earphone 100 is improved. Furthermore, when the earphone 100 is in use, the entrance 341 of the external auditory meatus 34 is not completely covered by the end section 1221 of the earphone 100. Therefore, external sound can enter the external auditory meatus 34 and be received by the inner ear. When something happens in the external environment with an accompanying audible alert of some kind, the user can receive the audible information immediately, which helps prevent the occurrence of accidents.

In this embodiment, the earphone 100 is an earphone used in the left ear. Similarly, an earphone used in the right ear can be provided in much the same way as that described above. In addition, the earphone 100 in this embodiment is a wired earphone. In other embodiments, a Bluetooth™ device and a holding structure can be formed in the earphone 100 to form a Bluetooth™ type earphone.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An earphone, comprising:
a shell, which defines a sound cavity therein; and
a speaker mounted in the shell, the speaker dividing the sound cavity into a front chamber at a front side of the speaker and a rear chamber at a rear side of the speaker;
wherein the shell comprises a front wall confronting the speaker and a peripheral side wall extending obliquely from a periphery of the front wall to the speaker, the front wall defines a first sound hole to communicate the front chamber of the shell with the outer environment of the earphone, and the side wall defines a second sound hole to communicate the front chamber of the shell with the outer environment of the earphone; and
when the earphone is in use, the first sound hole corresponds to the concha of the human ear and the second sound hole corresponds to an entrance of an external auditory meatus of the human ear.

2. The earphone of claim 1, wherein the speaker has a first center axis and the second sound hole has a second center axis inclined relative to the first center axis, an included angle between the first center axis and the second center axis being an acute angle.

3. The earphone of claim 2, wherein the included angle between the first center axis and the second center axis is less than 75 degrees and greater than 15 degrees.

4. The earphone of claim 2, wherein the side wall comprises an end adjacent to the front wall, and the second sound hole is defined in the end of the side wall.

5. The earphone of claim 1, wherein the side wall comprises a first netting cover at a position of the second sound hole to cover the second sound hole.

6. The earphone of claim 5, wherein the first netting cover is nylon netting or adhesive-bonded fabric.

7. The earphone of claim 5, wherein the front wall comprises a second netting cover to cover the first sound hole.

8. The earphone of claim 7, wherein the second netting cover is wire netting.

9. The earphone of claim 7, wherein an area of the first netting cover is less than an area of the second netting cover.

10. The earphone of claim 9, wherein the shell comprises a rear cover and a front cover engaged with the rear cover, and the first sound hole and the second sound hole are defined in the front cover.

11. The earphone of claim 10, wherein the rear cover comprises a main body engaged with the front cover and a handle portion extending outwardly from the main body, the handle portion comprises a wire passage and a sound passage separated from the wire passage by a spacer member, and both the wire passage and the sound passage communicate the rear chamber of the shell with the outer environment of the earphone.

12. An earphone, comprising:
a shell, which defines a sound cavity therein; and
a speaker mounted in the shell, the speaker dividing the sound cavity into a front chamber at a front side of the speaker and a rear chamber at a rear side of the speaker;
wherein the shell comprises a front wall confronting the speaker and a peripheral side wall extending obliquely from a periphery of the front wall to the speaker, the front wall defines a first sound hole to communicate the front chamber of the shell with the outer environment of the earphone, the side wall defines a second sound hole to communicate the front chamber of the shell with the outer environment of the earphone, the front wall comprises a first netting cover covering the first sound hole, the side wall comprises a second netting cover covering the second sound hole, the front wall has a first center axis, the second sound hole has a second center axis inclined relative to the first center axis, and an included angle between the first center axis and the second center axis is an acute angle.

13. The earphone of claim 12, wherein the included angle between the first center axis and the second center axis is less than 75 degrees and greater than 15 degrees.

14. The earphone of claim 12, wherein the speaker has a third center axis which is coinciding with the first center axis of the front wall.

15. The earphone of claim 12, wherein the side wall defines an end adjacent to the front wall, the second sound hole is defined at the end of the side wall.

16. The earphone of claim 12, wherein the first sound hole comprises through holes arranged around the first center axis of the front wall.

17. The earphone of claim 16, wherein an annular groove is defined in the front cover between the front wall and the side wall, a flange is formed at an edge of the first netting cover and attached to the groove of the front cover.

18. An earphone, comprising:
a shell; and
a speaker mounted in the shell;
wherein the shell comprises a first sound hole and a second sound hole located at a front side of the speaker for outputting sound from the speaker to the outer environment of the earphone, the first sound hole has a first center axis, the second sound hole has a second center axis, and an included angle between the first center axis and the second center axis is an acute angle; and
when the earphone is in use, the first sound hole corresponds to the concha of the human ear and the second sound hole corresponds to an entrance of an external auditory meatus of the human ear.

19. The earphone of claim 18, wherein the included angle between the first center axis and the second center axis is less than 75 degrees and greater than 15 degrees.

20. The earphone of claim 19, wherein the shell comprises a front wall confronting the speaker and a side wall extending obliquely from an edge of the front wall, the first sound hole is defined in the front wall, and the second sound hole is defined in the side wall.
